(19) United States
(12) Patent Application Publication
(10) Pub. No.: US 2006/0253797 A1
(43) Pub. Date: Nov. 9, 2006

(54) Presentation of user-specified display regions

(75) Inventors: Vikram Madan, Bellevue, WA (US); Andrew J. Fuller, Redmond, WA (US); Jeffrey W. Pettiross, Seattle, WA (US); Matthew P. Rhoten, Kirkland, WA (US); Yu-Kuan Lin, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/123,091

(22) Filed: May 6, 2005

(51) Int. Cl. G06F 9/00

(52) U.S. Cl. 715/792

(57) ABSTRACT

The reproduction of one or more selected regions from a primary desktop onto an extended desktop, without any other portion of the primary desktop, is disclosed. The user or a software application may thereby have discretion as to what is and is not presented on the extended desktop. Selected regions may be windows, regions that are custom-defined regardless of whether they include a window, or even pre-defined non-window regions. Because the selected regions are already on the user's primary desktop, the user is always able to view and manipulate the extended desktop, by manipulation of the primary desktop, without having to do anything special. In addition, windows or other regions that are obscured by other object on the primary desktop are not necessarily obscured on the extended desktop. An application programming interface is also described that allows a software application and/or a software developer to access reproduction functionality.

### FIELD OF THE INVENTION

Aspects of the present invention are directed to the reproduction of one or more regions of a primary desktop of a computer with an extended desktop of the same computer.

### BACKGROUND OF THE INVENTION

Typically, presentations (such as those that accompany speeches) are given using a computer. Typically, the presenter has access to primary and secondary display devices, where the primary display device is used by the presenter to control the computer and the secondary display device is presented for viewing by the audience. In such a configuration, the entire displayed image on the primary display device is usually cloned (i.e., duplicated) for display on the secondary display device. If the presenter is attempting to perform other functions on the computer while giving the presentation (such as taking notes or switching between applications), the audience also sees the actions that the presenter is taking. In addition, any other unexpected or otherwise automated activity performed by the computer may also be viewed by the audience (such as a received new email or instant-message notification). This can be quite embarrassing and awkward for the presenter, and may further raise privacy issues. The presenter may try to avoid these latter problems by configuring the computer prior to the presentation to turn off email and instant notification features, and then re-configuring the computer after the presentation to turn the features back on. However, this is inconvenient, time-consuming, and error-prone. In addition, such preventative measures do not resolve the problem of allowing the audience to view all actions taken by the user in interacting with the computer's user interface.

In an alternative configuration, some presenters use an extended desktop such that a primary desktop is displayed on the primary display device and the extended desktop is displayed on the secondary display device. Thus, any activities that affect only the primary desktop may likely not affect the extended desktop, and thus are hidden from the audience. However, there is no guarantee that a particular activity will not affect the extended desktop in an unintended or undesirable way. For example, it is possible that an unexpected notification or other automated activity associated with normal operations will occur at least in part on the extended desktop instead of only on the primary desktop as would be preferred by the presenter. Another drawback to this approach is that the extended desktop is no longer viewable and/or easily controllable from the primary desktop; only the most advanced users are able to successfully make a presentation by controlling the extended desktop from the primary desktop.

Accordingly, improved ways of controlling what is displayed on a primary and extended desktop are needed, especially in the realm of allowing a user to implement an effective and convenient presentation.

### SUMMARY OF THE INVENTION

Aspects of the present invention are directed to reproducing one or more selected regions from the primary desktop onto the extended desktop. The extended desktop does not display any other portion of the primary desktop. In this way, the user or a software application may have discretion as to what is and is not presented on the extended desktop. Only the extended desktop (and its contents) would be visible to the audience. For example, the user may engage in other tasks or communications privately, without having to worry about inadvertently reproducing the results of these actions onto the extended desktop where the results can be viewed by others. Selected regions may be windows, regions that are custom-defined regardless of whether they include a window (referred to herein as non-window regions), or even pre-defined non-window regions (e.g., a particular quadrant of the primary desktop). Because the selected regions are already on the user's primary desktop, the user is always able to view and manipulate what is displayed on the extended desktop, by manipulation of the selected regions on the primary desktop, without having to do anything special. In addition, windows or other regions that are obscured by other object on the primary desktop are not necessarily obscured on the extended desktop.

Further aspects of the present invention are directed to an application programming interface that allows a software application and/or a software developer to access various reproduction functionality. For example, a software application may be alerted to the reproducing status of a particular selected region. Also, a software application may be able to enable or disable reproducing a particular window, such that a user may or may not be able to select that window to be reproduced onto the extended desktop.

These and other aspects of the invention will be apparent upon consideration of the following detailed description of illustrative embodiments.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a functional block diagram of an illustrative computer that may be used to implement various aspects of the present invention.

FIG. 2 is an illustrative diagram of a computer having a primary desktop and an extended desktop.

FIG. 3 is another illustrative diagram of a computer having a primary desktop and an extended desktop.

FIG. 4 is a screenshot of an illustrative window having an extended desktop reproduction control.

FIG. 5 is another illustrative diagram of a computer having a primary desktop and an extended desktop.

FIG. 6 is another illustrative diagram of a computer having a primary desktop and an extended desktop.

FIG. 7 is a functional block diagram showing illustrative points from which images may be derived from an illustrative graphics system of a computer.

### DETAILED DESCRIPTION OF ILLUSTRATIVE EMBODIMENTS

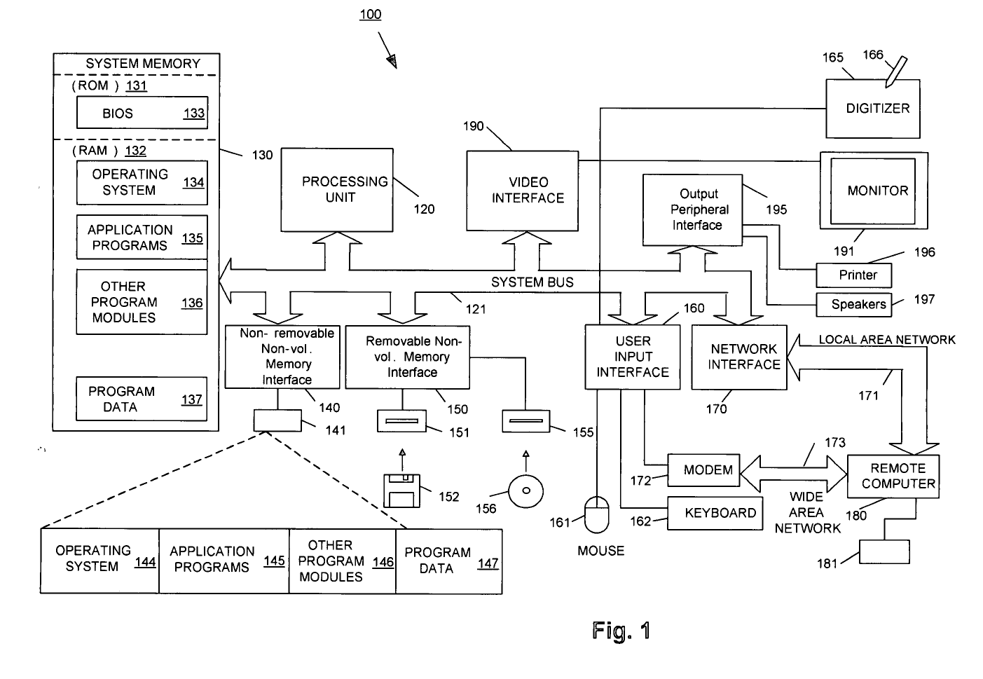

FIG. 1 illustrates an example of a suitable computing system environment 100 in which aspects of the invention may be implemented. Computing system environment 100 is only one example of a suitable computing environment and is not intended to suggest any limitation as to the scope of use or functionality of the invention. Neither should computing system environment 100 be interpreted as having any dependency or requirement relating to any one or combination of components illustrated in illustrative computing system environment 100.

The invention is operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. The invention may also be operational with distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 100. Components of computer 100 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 100 typically includes a variety of computer-readable media. Computer readable media can be any available media that can be accessed by computer 100 such as volatile, nonvolatile, removable, and non-removable media. By way of example, and not limitation, computer-readable media may include computer storage media and communication media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF) (e.g., BLUETOOTH, WiFi, UWB), optical (e.g., infrared) and other wireless media. Any single computer-readable medium, as well as any combination of multiple computer-readable media, are both intended to be included within the scope of the term “computer-readable medium” as used herein.

System memory 130 includes computer storage media in the form of volatile and/or nonvolatile memory such as ROM 131 and RAM 132. A basic input/output system (BIOS) 133, containing the basic routines that help to transfer information between elements within computer 100, such as during start-up, is typically stored in ROM 131. RAM 132 typically contains data and/or program modules that are immediately accessible to and/or presently being operated on by processing unit 120. By way of example, and not limitation, FIG. 1 illustrates software in the form of computer-executable instructions, including operating system 134, application programs 135, other program modules 136, and program data 137.

Computer 100 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. Hard disk drive 141 is typically connected to system bus 121 through a non-removable memory interface such as an interface 140, and magnetic disk drive 151 and optical disk drive 155 are typically connected to system bus 121 by a removable memory interface, such as an interface 150.

The drives and their associated computer storage media discussed above and illustrated in FIG. I provide storage of computer-readable instructions, data structures, program modules and other data for computer 100. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are assigned different reference numbers in FIG. 1 to illustrate that they may be different copies. A user may enter commands and information into computer 100 through input devices such as a keyboard 162 and a pointing device 161, commonly referred to as a mouse, trackball or touch pad. Such pointing devices may provide pressure information, providing not only a location of input, but also the pressure exerted while clicking or touching the device. Other input devices (not shown) may include a microphone, joystick, game pad, satellite dish, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 191 or other type of display device is also coupled to system bus 121 via an interface, such as a video interface 190. Video interface 190 may have advanced 2D or 3D graphics capabilities in addition to its own specialized processor and memory.

Computer 100 may also include a touch-sensitive device 165, such as a digitizer, to allow a user to provide input using a stylus 166. Touch-sensitive device 165 may either be integrated into monitor 191 or another display device, or be part of a separate device, such as a digitizer pad. Computer 100 may also include other peripheral output devices such as speakers 197 and a printer 196, which may be connected through an output peripheral interface 195.

Computer 100 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 100, although only a memory storage device 181 has been illustrated in FIG. 1. The logical connections depicted in FIG. 1 include a local area network (LAN) 171 and a wide area network (WAN) 173, but may also or alternatively include other networks, such as the Internet. Such networking environments are commonplace in homes, offices, enterprise-wide computer networks, intranets and the Internet.

When used in a LAN networking environment, computer 100 is coupled to LAN 171 through a network interface or adapter 170. When used in a WAN networking environment, computer 100 may include a modem 172 or another device for establishing communications over WAN 173, such as the Internet. Modem 172, which may be internal or external, may be connected to system bus 121 via user input interface 160 or another appropriate mechanism. In a networked environment, program modules depicted relative to computer 100, or portions thereof, may be stored remotely such as in remote storage device 181. By way of example, and not limitation, FIG. 1 illustrates remote application programs 182 as residing on memory device 181. It will be appreciated that the network connections shown are illustrative, and other means of establishing a communications link between the computers may be used.

As discussed previously, touch-sensitive device 165 may be a device separate from or part of and integrated with computer 100. In addition, any or all of the features, subsystems, and functions discussed in connection with FIG. 1 may be included in, coupled to, or embodied integrally as part of, a tablet-style computer. For example, computer 100 may be configured as a tablet-style computer a or handheld device such as a PDA where touch-sensitive device 165 would be considered the main user interface. In such a configuration touch-sensitive device 165 may be considered to include computer 100. Tablet-style computers are well-known. Tablet-style computers interpret gestures input to touch-sensitive device 165 using stylus 166 in order to manipulate data, enter text, create drawings, and/or execute conventional computer application tasks such as spreadsheets, word processing programs, and the like. Input may not only be made by stylus 166, but also by other types of styli such as a human finger.

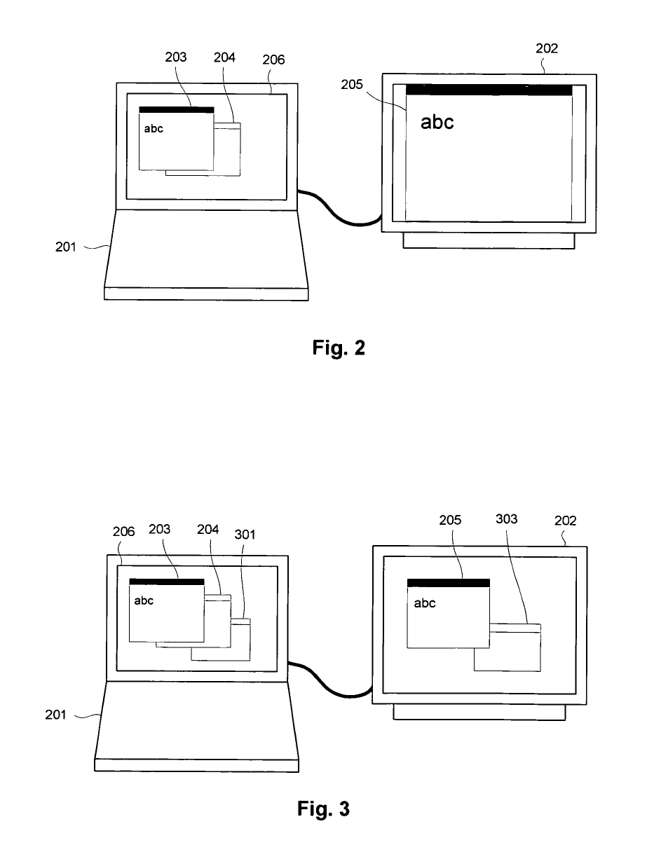

Referring to FIG. 2, an illustrative computer 201 is shown having a primary display device 206. Computer 201 may be configured, for example, as described with regard to FIG. 1. In the shown embodiment, computer 201 is a laptop computer. However, computer 201 may be any type of computer such as a desktop computer, a tablet-style computer, a handheld computer, or a server. In addition, computer 201 is coupled to a secondary display device 202. Primary and secondary display devices 206, 202 may each be any type of display device such as a cathode-ray tube (CRT) monitor, a liquid-crystal display (LCD) device, or a projector.

A user may utilize computer 201 to simultaneously control the content displayed on primary display device 206 and secondary display device 202. As previously discussed, graphical user interface (GUI) based operating systems exist, such as the well-known Microsoft WINDOWS line of operating systems, that allow a user to extend a primary desktop, resulting in both the primary desktop and an extended desktop. In the following examples, it will be assumed that the user has configured computer 201 such that primary display device 206 displays the primary desktop while secondary display device 202 displays the extended desktop.

The extended desktop may be useful in a variety of scenarios. For instance, the extended desktop may be used to simply extend the amount of displayable area available to the user, treating the primary and secondary desktops as one larger continuous desktop. This would allow the user to position larger objects such as windows so as to extend across both the primary and the extended desktop area, and to easily move objects between the primary and extended desktop. In that scenario, while the extended desktop may be physically separate from the primary desktop (e.g., displayed on a separate display device), from the user's point of view the extended desktop and the primary desktop together may be considered merely to be part of a single larger desktop. However, the extended desktop may be useful in other additional ways. As discussed herein, the extended desktop may be used as a presentation platform that, from the user's point of view, is also functionally separate from the primary desktop. In such a configuration, a user may treat the primary desktop (displayed on primary display device 206) as a relatively “private” portion of the total desktop area and the extended desktop (displayed on secondary display device 202) or a portion thereof as a relatively “public” presentation portion. The extended portion may reproduce one or more portions of the primary desktop. For example, the user may give a speech while presenting a slide deck or other supporting material on the extended desktop displayed on display device 202. Also while giving the speech, the user may interact with the graphical user interface portion that is displayed on the primary desktop (on primary display device 206) to control the slide deck and/or other operations of computer 201. Thus, the slide deck may be displayed on both the primary desktop and the extended desktop. User interaction with the slide deck on the primary desktop would affect the presentation of the slide deck presented on the extended desktop.

For example, a slide deck may be presented on the primary desktop (on display device 206) in window 203, which may be an always-on-top window (meaning that, when it is displayed, it is always displayed above any other layers on the extended desktop). The user may interact with window 203 to affect the presentation of the slide deck. Simultaneously, the same slide deck is displayed on the extended desktop (on display device 202) in window 205. The content of window 205, also referred to herein as a projected representation of the content of window 203, may be a real-time updated (or updated at variable or fixed intervals, such as about once per second) copy of the content currently displayed in window 203. For example, when the next slide is selected in the slide deck shown in window 203, the next slide would also be simultaneously shown in window 205.

Window 205 may be of the same size as window 203 or of a different size. For example, window 205 may have the same ratio of height versus width as window 203 but may be smaller or larger than window 203. This provides for an undistorted view of the original content of window 203 while allowing the size of window 205 to be freely determined. In some embodiments, window 205 may be automatically sized to letterbox format, i.e., proportionally scaled to fit the most constrained dimension of display 202. In further embodiments, window 205 may be automatically sized and/or shaped to match the displayable area of display device 202, thus resulting in window 205 being a full-screen window. It should be noted that any windows discussed herein, whether on the primary or extended desktops, may or may not include displayed borders, handles, menus, etc. In other words, the displayed window may be limited to the content of the window only, or it may include both the content as well as other features that are recognizable to a user as a conventional window for the particular operating system being used. For example, where window 205 is a letterbox-sized window or a full-screen window, it may be desirable that window 205 not have any extraneous borders, handles, menus, etc. to distract from the presentation.

While the user is reproducing the content of window 203 onto the extended desktop, the user may also wish to not reproduce remaining portions of the desktop. For example, the user has selected window 203 for reproducing the content therein but has not selected window 204 for reproducing the content therein. Thus, the content of window 204 would not be displayed on the extended desktop. Nor would any other objects on the primary desktop unless they were selected for reproducing by the user or by a software application. This configuration may be desirable where the user may not want to reproduce all the content of the primary desktop with the audience of the speech. For example, window 204 may be an email that the user would not want to be presented to his or her audience. However, the user may decide to select window 204 in addition to window 203. Because in this example only one window at a time would be shown on the extended desktop, computer 201 may need to make a determination as to which of windows 203, 204 to reproduce onto the extended desktop at any given time. For example, the presently active window (the window that is at the top of the Z-order) may be the window that is reproduced at any given time onto the extended desktop, while any non-active windows (lower on the Z-order) would not be reproduced onto the extended desktop unless and until one of them becomes the presently-active window. The Z-order is a concept used in various graphical-user-interface operating systems (for example, Microsoft WINDOWS line of operating systems) and refers to the ordered layering of objects such as windows relative to one another. A window that is presently active would be displayed at the top visible layer (i.e., not blocked by other windows) and would thus be at the top of the Z-order. A window immediately beneath the presently active window would be displayed at least partially blocked by the presently active window and would be under that window in the Z-order. The Z-order may define the layering order of any number of objects.

In the example of FIG. 2, the user may manipulate window 203 without necessarily affecting window 205 or its content. This is because window 205 is already automatically sized and positioned in accordance with the displayable area of display device 202, without regard to the size or position of window 203. For instance, the user may move window 203 around on the primary desktop, or re-size window 203. Where window 205 is full screen or in letterbox format, such moving and re-sizing would not affect how window 205 and its content are presented. However, in the illustrative embodiment shown in FIG. 3, window 205 has a size and/or position on the extended desktop that at least partially depends on the size and/or position, respectively, of associated window 203. In this embodiment, if the user moves window 203 to the right (for example), then window 205 may likewise move to the right to mimic the movement of window 203. Or, if the user increases (for example) the size of window 203, then window 205 may likewise increase in size to mimic the re-sizing of window 203.

In the example of FIG. 3, window 204 is not selected for reproducing onto the extended desktop, however window 301 is selected for reproduction. In response, a window 303 is presented on the extended desktop that contains the content of window 301. Like window 203, manipulation of window 301 affects the size and/or position of associated window 303. Windows 205 and 303 may be treated differently depending upon the Z-orders of their associated source windows 203, 301. In the shown example, window 203 is the presently active window (at the top of the Z-order), and window 301 is below window 203 in the Z-order and is thus not presently active. Because window 203 is at the top of the Z-order, associated window 205 will dynamically show the current content of window 203 in real time. However, because window 301 is inactive and below window 203 in the Z-order, associated window 303 will show a frozen snapshot of the content of window 301. The snapshot may be of the content of window 301 at the moment that window 301 is changed from being an active window to being an inactive window. Alternatively, window 303 may show any other content (or lack thereof, such as a blank window), which may or may not be related to the content of window 301, in place of the live content of associated source window 301. In yet another embodiment, window 303 may be continuously updated with the live content of window 301, regardless of whether window 301 is inactive.

Thus, with reference to both FIGS. 2 and 3, the user may independently select one or more different windows for reproducing onto the extended desktop. The various different windows may be from the same software application or from different software applications and/or from the operating system. For example, window 203 may be generated by presentation software (such as Microsoft POWERPOINT presentation software) and window 301 may be generated by a separate word processing application.

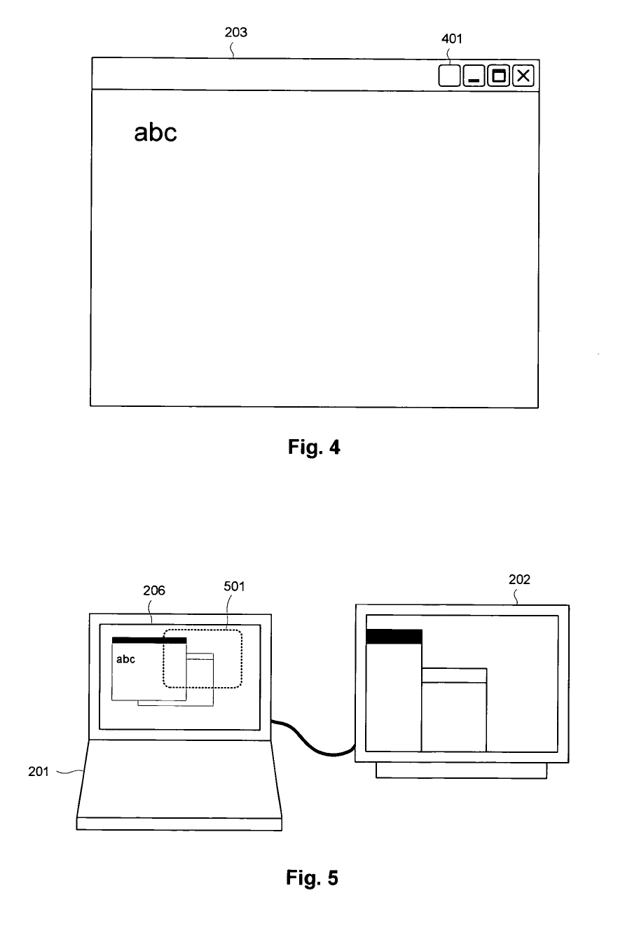

Any of windows 203, 204, 301 on the primary desktop may have one or more displayed controls that may allow the user to conveniently select or deselect a window for reproducing onto the extended desktop. For instance, referring to FIG. 4, window 203 is shown in more detail to include a control 401. Selection of control 401 by the user toggles between reproducing window 203 and not reproducing window 203 onto the extended desktop. Although control 401 is in the position shown on the window control area, such a control may be located anywhere. Also, although control 401 is shown on the form of a button control, such a control may be provided in any form, such as a drop-down menu selection or a toggle switch.

Thus far the discussion has been as to the selection of windows to be reproduced from the primary desktop to the extended desktop. In general, however, any region of the primary desktop may be designated to be reproduced onto the extended desktop. The designation of a window is a convenient way to designate a predefined region for reproduction, however the user and/or a software application may designate a non-window custom or pre-defined region of the primary desktop without regard to any windows or other displayed objects.

For example, referring to FIG. 5, a user has selected a region 501 of the primary desktop for reproducing onto the extended desktop. In this example, region 501 is arbitrary with respect to any objects (such as window 206) on the primary desktop. The user may receive an indication as to which region(s) have been selected for reproduction onto the extended desktop. For example, a selected region may be shown in a layered configuration with respect to the remainder of the primary desktop, or it may be reproduced onto another portion of the primary desktop in a picture-in-picture arrangement that shows a smaller version of the selected region or a smaller version of the entire primary desktop with the selected regions indicated. In addition, controls may be provided on the primary desktop to manipulate the shape, rotation, and/or size of the selected regions, as well as to temporarily or permanently end the reproduction of one or more selected regions.

As can be seen, display device 202 shows a live copy of region 501 as an enlarged letterbox version. In this example, region 501 is selected using a graphical boundary selection tool, which is a tool commonly found in drawing software applications. The boundary selection tool may present a pre-defined shape, such as a circle or rectangle, the size and shape of which may be manipulated by the user. Or, the boundary selection tool may allow the user to hand-draw a custom boundary or to “rubber band” a boundary around a displayed object (rubber banding is also known in conventional drawing programs). Where a particular displayed object is selected for reproduction, that object may continue to be reproduced as originally selected even though the object may later be moved about the primary desktop or otherwise manipulated (e.g., stretched or rotated). Generally speaking, region 501 may be selected using any graphical or non-graphical selection method desired. For example, a list of windows may be presented to the user, and the user may select one or more windows from the list for reproduction. Also, a particular software application may be configured such that windows that the software application opens are by default reproduced or not reproduced, as desired. It should further be noted that region 501 may have boundaries other than the rectangular boundaries shown. For instance, region 501 may have circular boundaries or any other geometric or non-geometric boundary arrangement.

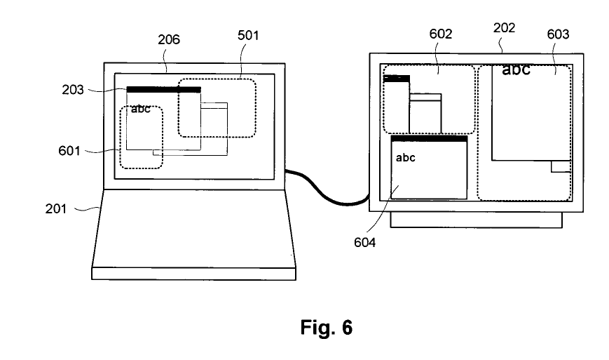

Region selections may also be mixed. For example, a set of selected regions may include both window and non-window regions. Or, the user may specify a particular region that is a fixed selected area on the primary desktop. This fixed area may be defined regardless of the location of an existing window or other object. In this situation, any objects or other screen content that enter and exit the selected region would also be reproduced onto the extended desktop in like manner. In addition, the user may be able to specify that the only windows that are to be reproduced onto the extended desktop are those that enter the fixed region (and possibly also only those windows that are selected for to be reproduction or not otherwise prohibited from reproduction). This may be useful where the primary desktop is of a higher screen resolution than the device used to display the extended desktop. In this case, the user may want to designate a smaller region of the primary desktop so that the content in the selected region will be more legible on the extended desktop. Referring to FIG. 6, the user has selected three items on the primary desktop for reproducing onto the extended desktop: window 203, region 501, and region 601. These are respectively associated with projected representations 604, 602, and 603 on the extended desktop. In this particular embodiment, computer 201 displays projected representations 602, 603, 604 in a tiled configuration. This means that projected representations 602, 603, 604 are displayed next to each other on display device 202 without overlapping. Of course, projected representations 602, 603, 604 may be displayed in any of the number of ways previously discussed, or in other ways. For example, any of the projected representations previously discussed (where there are a plurality of projected representations to be displayed) may be tiled side-by-side, overlaid, visually merged, displayed one at a time, or presented in any other manner desired and that makes sense for the particular context. Where partially or fully overlaid, the projected representations may be opaque or else partially transparent (such as by using known alpha-blending techniques). The way that various selected windows or other regions are reproduced and displayed on the extended desktop is configurable by the user and/or by software applications.

When selecting (or deselecting) one or more regions for reproducing onto the extended desktop, the user may select (or deselect) the regions one at a time or simultaneously, such as in groups. When selected one at a time, the way that the projected representations of those selections are displayed may dynamically change with each new selection (or deselection). For example, if only a single region (such as a first window generated by a first software applications) is selected for reproduction, then that region may be displayed as a full-screen or letterbox projection representation on the extended desktop. Then, if the user adds a second different region (such as a different second window generated by a different second software application), in response computer 201 may cause the projection representation of the first region to change to accommodate the projection representation of the second region. For example, the projection representation of the first region may shrink so that it may be tiled alongside the projection representation of the second region. Or, the projection representation of the first region may shrink and be partially overlaid by the projection representation of the second region. These are simply examples; multiple projection representations may be presented on the extended desktop in any of a number of ways.

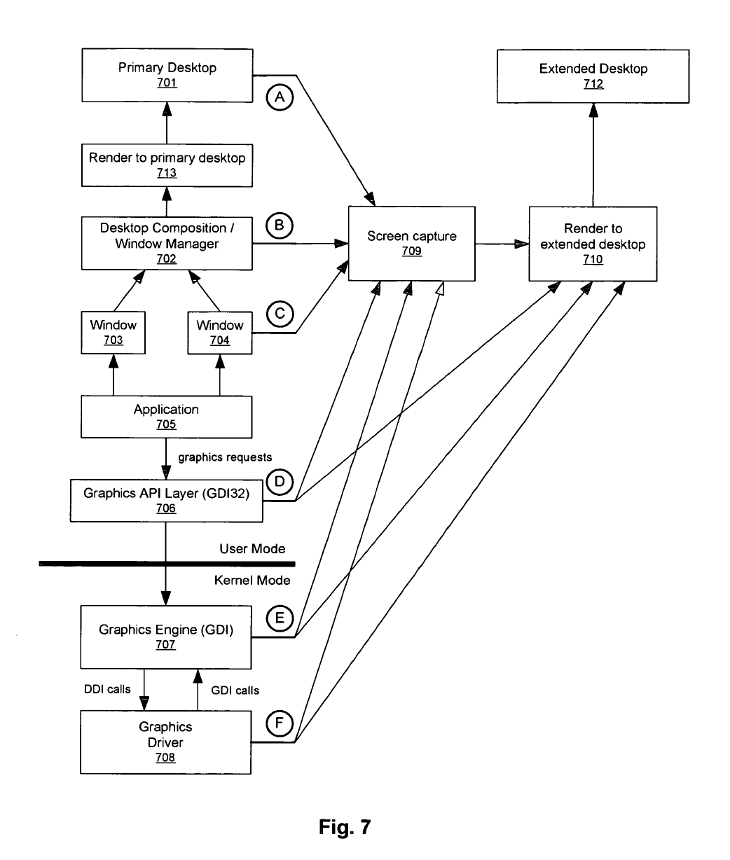

To generate a projection representation, data from the selected region (e.g., pixel data) is obtained and manipulated as needed. There are several possibilities in how source data may be obtained from a selected region. For example, referring to FIG. 7, a high-level view of an illustrative graphics stack for a graphical user interface operating system is shown in functional block diagram form. The graphics stack is representative of what is provided by the Microsoft WINDOWS line of operating systems, however similar stacks are also found in other operating systems. In the user mode, the graphics stack includes a graphics application programming interface (API) layer module 706, which receives graphics requests from an application 705. For example, application 705 may request graphics API layer module 706 to assist it with generating one or more windows 703, 704. A desktop composition/window manager 702 composes windows 703, 704 in preparation for displaying windows 703, 704 on the display. In response to receiving a graphics request, graphics API layer module 706 sends a request to a graphics engine 707 in the kernel mode, which generates graphics with assistance from a graphics driver 708.

For purposes of explanation, it will be assumed that the selected item to be reproduced onto the extended desktop will be window 704, which is presently displayed on the primary desktop. Data for generating the associated projected representation may be taken from points A through F as shown in FIG. 1. Taking data from point A involves capturing an image of pixels that have already been rendered to the primary desktop. More precisely, the pixels have been sent to a frame buffer containing the final image that is displayed to the user. Taking data from point B involves duplicating the pixels prior to rendering them to the desktop. The pixels may be captured even though they have not yet been displayed to the user. This may be more desirable than taking data from point A because the data may include all pixels from window 704 even if some or all of window 704 is obscured, such as by another window in front of window 704. On the other hand, only those pixels from window 704 that are actually rendered to the display would be able to be taken from point A.

Taking data from point C involves capturing an image of the surface of window 704 at the point at which window 704 is visually composed, independent of the final desktop image composition. This may be desirable and efficient where, as in the present example, the selected item to be reproduced is an entire window. However, where the selected item to be reproduced is a non-window region of the primary desktop, then point C may not be desirable as a data source. Taking data from point D, E, or F involves capturing images at relatively lower levels in the graphics stack. At these points, the images may be captured either by duplicating the results of the graphics operations (i.e., copying the pixels) or duplicating the graphics operations themselves (i.e., rendering the pixels twice, once in application 705 and once in the capture frame to be sent to the extended desktop). Duplicating all of the operations at such a low level may be desirable as it may result in higher performance and/or higher fidelity of the captured image. This is because relatively little processing has been done to the raw pixel data at these levels.

As further illustratively shown in FIG. 7, data taken from points A through F may be sent to or requested by a screen capture software module 709, which may then send the captured pixel data to a render module 710 that renders it to an extended desktop 712 in a desired format. Alternatively, data taken from points D, E, and F may be rendered directly to the extended desktop in a manner similar to or different from how the original data is rendered to primary desktop 701.

An application program interface (API) may be provided that allows software applications (and software application developers) access to at least some of the above-described functionality. For example, the API may include a way for a software application to enable or disable window reproduction onto the extended desktop for a particular window. If disabled, the user may not be able to override and thus may not be able to reproduce the reproduction-disabled window unless the software application allows it. This may be useful in a variety of situations, such as where the particular window contains confidential information that is not to be reproduced onto the extended desktop (thereby risking its divulgence to the audience of the user's speech, for example). For example, an email software application may be able to prevent emails having a confidential status from being reproduced, although emails having a normal unconfidential status may still be reproduced. Reproduction may be visually disabled by, e.g., requesting that control 401 not be provided on a given window, thus eliminating the ability of the user to select reproducing that window. The request to disable or enable reproduction may include an identification of the particular window (such as the name of the window), along with an indication of enable or disable (such as a binary flag). Alternatively, separate requests may be defined for enabling and disabling reproduction. The API may also include messages informing the software application when a particular window is about to be reproduced (but has not yet started being reproduced), or has started being reproduced, or has stopped being reproduced. The message may include an identification of the particular window, such as the name of the window. In addition to being able to enable or disable reproduction of a window, the capability may be provided to programmatically actually initiate or end reproduction of a window. The API may also provide the ability for an application to customize a selected window representation on the extended desktop. For example, a first application may request a letterbox representation whereas as second application may request the relative representation.

The above-mentioned functionality and associated API may be implemented as computer-executable instructions that are part of one or more software applications and/or in the operating system itself. By implementing region reproduction in the operating system, such reproduction may be done for any window of any software application, even those software applications that are unaware of the reproduction capabilities.

Thus, a way of reproducing one or more selected regions from the primary desktop onto the extended desktop, without displaying any other portion of the primary desktop, has been described, along with associated APIs. Users may now, with confidence, engage in private tasks or communications on the primary desktop without inadvertently sharing the results of these actions with others that are viewing the extended desktop.

What is claimed is:

1. A computer-readable medium storing computer-executable instructions for performing steps comprising:
receiving a user selection of a plurality of regions of a graphical user interface displayed on a first display device; and
displaying representations of the regions, but not any of the remainder of the graphical user interface, on a second different display device.

2. The computer-readable medium of claim 1, wherein at least one of the regions is a window.

3. The computer-readable medium of claim 2, wherein the user selection of the window is a user selection of a control displayed on a control area of the window.

4. The computer-readable medium of claim 1, wherein the step of displaying includes scaling at least one of the representations so as to extend fully across at least one displayable dimension of the second display device.

5. The computer-readable medium of claim 4, wherein the computer-executable instructions are further for choosing the at least one of the representations such that it is associated with a window on the first display device that is currently active.

6. The computer-readable medium of claim 1, wherein the step of displaying includes tiling the representations side-by-side on the second display device.

7. The computer-readable medium of claim 1, wherein the step of displaying includes at least partially overlaying the representations.

8. A computer-readable medium storing computer-executable instructions for performing steps comprising:
receiving a user selection of a first window within a primary desktop, the first window being generated on the primary desktop by a first software application;
displaying a first representation of a content of the first window, but not any of the remainder of the primary desktop, within an extended desktop;
after displaying the first representation, receiving a user selection of a different second window within the primary desktop, the second window being generated on the primary desktop by a different second software application;
displaying a second representation of a content of the second window, but not any of the remainder of the primary desktop, within the extended desktop.

9. The computer-readable medium of claim 8, wherein the user selection of the first window is a user selection of a control displayed on a control area of the first window.

10. The computer-readable medium of claim 8, wherein the step of displaying the first representation includes scaling the first representation so as to extend fully across at least one displayable dimension of a display device that is displaying the extended desktop, and wherein the step of displaying the second representation includes scaling the second representation so as to extend fully across the at least one displayable dimension of the display device.

11. The computer-readable medium of claim 10, wherein the primary desktop is displayed on a second display device different from the first display device.

12. A computer-readable medium storing computer-executable instructions for performing steps comprising:
receiving a user selection of a first region within a primary desktop;
displaying a first representation of the first region of the desktop, but not any of the remainder of the primary desktop, within an extended desktop;
after displaying the first representation, receiving a user selection of a different second region within the primary desktop;
displaying a second representation of the second region, simultaneously with a third representation of the first region, within the extended desktop.

13. The computer-readable medium of claim 12, wherein the third representation is identical to the first representation.

14. The computer-readable medium of claim 12, wherein the third representation is a smaller version of the first representation.

15. The computer-readable medium of claim 12, wherein the third representation is a semi-transparent version of the first representation.

16. The computer-readable medium of claim 12, wherein each of the first and second regions is a different window generated by a different software application.

17. The computer-readable medium of claim 12, wherein the step of displaying first representation includes scaling an image of the first region so as to extend fully across at least one displayable dimension of a display device associated with the second desktop.

18. The computer-readable medium of claim 12, wherein the computer-executable instructions further include an interface that allows a software application to enable or disable a window on the primary desktop from being reproduced onto the extended desktop.

19. The computer-readable medium of claim 12, wherein the computer-executable instructions further include an interface that provides a message to a software application that indicates a reproduction status of a region of the primary desktop.

20. The computer-executable instructions of claim 12, wherein the computer-executable instructions are part of an operating system.
